(19) United States
(12) Patent Application Publication
(10) Pub. No.: US 2023/0000014 A1
(43) Pub. Date: Jan. 5, 2023

(54) Budding Foliage Cultivation Table

(71) Applicant: Ramundy Springfield, Stockton, CA (US)

(72) Inventor: Ramundy Springfield, Stockton, CA (US)

(21) Appl. No.: 17/364,871

(22) Filed: Jun. 30, 2021

(51) Int. Cl. A01D 39/00

(52) U.S. Cl. CPC A01D 39/00

(57) ABSTRACT

The present invention pertains to a novel budding foliage cultivation table for growing plants, shrubs, vegetation and other forms of foliage in an industrial workplace environment that is compliant with the Americans With Disabilities Act. The inventive budding foliage cultivation table is constructed to facilitate lateral movement during use, which allows for adjustable isle spacing, to accommodate 36-inch workplace isles in compliance with the Americans With Disabilities Act.

This Utility patent application claims priority from Provisional Patent Application Ser. No. 63/047,173.

### FIELD OF THE INVENTION

The present invention pertains to a novel cultivation table for growing plants, shrubs, vegetation and other forms of foliage in an industrial workplace environment that is compliant with the Americans With Disabilities Act. The inventive budding foliage cultivation table is constructed to facilitate lateral movement during use, which allows for adjustable isle spacing, to accommodate 36-inch workplace isles in compliance with the Americans With Disabilities Act.

The inventive budding foliage cultivation table comprises an inventive roller guide assembly having a plurality of vertical aluminum rollers. A plurality of lower rollers allow a surface for the inventive budding foliage cultivation table to travel upon, while a plurality of upper rollers are constructed to prevent the inventive budding foliage cultivation table from flipping over off of the inventive base of the cultivation table according to the present invention. A plurality of lateral rollers keep the inventive budding foliage cultivation table from binding, to ensure smooth transition during forward and backward movement of the inventive budding foliage cultivation table during use. The inventive roller guide assembly facilitates 36-inch lateral movement of the inventive budding foliage cultivation table to provide ADA complaint workspace isles during use according to the present invention.

### BACKGROUND

More than 50 million Americans with disabilities are potential employees, customers, and otherwise marketplace consumers of businesses all across the Country. Smart, profitable and sustainable businesses maximize their market presence, productivity and corresponding revenue streams by ensuring that all prospective and actual patrons and employees are afforded safe, well-designed access with respect to ingress, egress and all through out a business' topography. Maximized accessibility makes good business sense, as fully accessible businesses and workplaces attract new customers, facilitate diversifying workplace employment opportunities, and potentially expand a company's footprint into emerging fields and new areas of expertise.

Within businesses and workplace venues, isles, routes and other access pathways that are obstructed or narrowly constructed render such buildings inaccessible to—and unusable by—customers, employees or other patrons with disabilities. According to the United States Department of Justice, Civil Rights Division, the Americans with Disabilities Act (“ADA”) requires businesses that service the American public to remove access barriers from older buildings and to design and build new facilities to provide ADA-compliant access to customers, patrons and employees with disabilities.

A pivotal component of ADA compliance is constructing and maintaining existing and new structures to facilitate full use and access by people with disabilities. If key structural and design components of public access buildings, such as ingress and egress, routes and isle space throughout an establishment, restroom access and parking structures are not maintained in compliance with the ADA, then public access is reduced—or completely eliminated. For instance, prospective, existing and future employees, customers and patrons with disabilities will not be ale to effectively work or shop in venues if access routes through internal isle ways or ingress and egress points are constructed too narrowly. Thus, the ADA requires that such internally disposed isles and other pathways in public access establishments be constructed to provide for not less than 3 feet (36 inches) in full width. According to the ADA, the minimum clear width for a single wheelchair passage must be 32 inches at a point for a maximum length of 24 inches and 36 inches continuously.

The present invention solves the long-standing problem of conventional foliage cultivation equipment and corresponding workspaces not being ADA compliant, specifically with respect to creating wheelchair accessible, 36-inch workspace isles in industrial cultivation facilities. In order to achieve ADA compliance in this regard, the inventive budding foliage cultivation table comprises an inventive roller guide assembly, which facilitates 36-inch lateral movement of the inventive budding foliage cultivation table to provide ADA complaint workspace isles during use according to the present invention. The inventive roller guide assembly comprises a plurality of vertical aluminum rollers. A plurality of lower rollers allow a surface for the inventive budding foliage cultivation table to travel upon, while a plurality of upper rollers are constructed to prevent the inventive budding foliage cultivation table from flipping over off of the inventive base of the budding foliage cultivation table according to the present invention. A plurality of lateral rollers keep the inventive budding foliage cultivation table from binding, to ensure smooth transition during forward and backward movement of the inventive budding foliage cultivation table during use.

The inventive roller guide assembly is attached to the base of the inventive budding foliage cultivation table. Collectively, the inventive roller guide assembly and corresponding plurality of rollers facilitate the expansion and/or contraction of the inventive budding foliage cultivation table width to create ADA Compliant 36-inch workspace isles. Moreover, during use of the inventive budding foliage cultivation table, the inventive roller guide assembly is anchored to the workplace floor, which allows the inventive budding foliage cultivation table to travel at least 36 inches laterally, creating an effective weight distribution to achieve 36 inch lateral movement in a safe manner, eliminating the prospect of Table malfunction, including overturning, collision, table damage and a variety of potential workplace injuries.

An additional inventive safety feature of the present invention comprises an inventive cam lock, which is a part of the inventive roller guide assembly, and stabilizes the inventive budding foliage cultivation table in a desired stationary work position to enhance safety during use. This safety feature thus minimizes the prospect of workplace injuries during use. For instance, in the unexpected event of an earthquake, the inventive budding foliage cultivation table in its locked position would remain stationary and in-tack despite corresponding ground movement.

In addition, conventional foliage cultivation equipment is typically fragile in structural design, and offers trellis structures lacking stable structural integrity. Conventional foliage cultivation equipment is typically designed for the growth and harvesting of plants such as strawberries, lettuce, roses and the like, which actually require a design significantly different than an effective design for growing high density budding foliage at maximum capacity.

Conventional foliage cultivation equipment is also incapable of supporting high density budding foliage growth incorporating planting beds and pots, which minimize cannabis cultivation, growth medium choices, harvest and foliage yield.

The inventive budding foliage cultivation table is powder-coated to minimize or even eliminate short term and long-term corrosion damage, which creates superior corrosion protection for the entire inventive budding foliage cultivation table according to the present invention.

The inventive budding foliage cultivation table comprises a fully-welded structure, including heavy-gaged steel to fortify the structural integrity of the inventive budding foliage cultivation table, and electronically adhered powder-coating to provide superior corrosion protection and extended longevity of the inventive budding foliage cultivation table according to the present invention.

More specifically, the inventive budding foliage cultivation table comprises: a carriage assembly, comprising a budding foliage growing surface; a taller assembly, comprising a plurality of trailer units attached to said budding foliage growing surface; a roller guide assembly, comprising a plurality of aluminum rollers, to facilitate lateral movement of said budding foliage growing surface and said budding foliate cultivation table; and a base assembly, comprising a strut assembly, and plurality of anchor plates, to support and stabilize said budding foliage cultivation table in a desired location.

The budding foliage growing surface comprises a fully welded structure having a powder coating to facilitate corrosion protection. The carriage assembly further comprises a plurality of locking holes, which lock the budding foliage growing surface into a desired, stationary position. A first trailer unit is attached to the carriage assembly, to facilitate increasing budding foliage density during use of the budding foliage cultivation table. A plurality of additional trailer units are sequentially attached to the first trailer unit to increase budding foliage density during use of the budding foliage cultivation table.

A bumper unit comprising a segment of steel is bolted to the carriage assembly and to the trailer assembly, to inhibit metal-to-metal contact during use and nonuse of the budding foliage cultivation table. A trellis net assembly comprising a trellis mount is welded to the carriage assembly and to the trailer assembly, to increase budding foliage density during use of the budding foliage cultivation table. The trellis net assembly further comprises an extended rod, having a plurality of connection points, to facilitate connecting the trellis net assembly to the carriage assembly and to the trailer assembly, to increase budding foliage density during use of the budding foliage cultivation table. A plurality of tray inserts are positioned atop the budding foliage growing surface of the carriage assembly, to increase budding foliage density during use of the budding foliage cultivation table.

The roller guide assembly comprises: a plurality of lower aluminum rollers, which facilitate providing a surface upon which the budding foliage cultivation table can move laterally; a plurality of upper aluminum rollers, which prevent the budding foliage cultivation table from disengaging with the base assembly; and a plurality of lateral aluminum rollers, which prevent the budding foliage cultivation table from binding, to facilitate smooth transition during movement of the budding foliage cultivation table. The roller guide assembly facilitates moving laterally the budding foliage cultivation table during use, to achieve at least a 36-inch isle space during use of the budding foliage cultivation table.

The base assembly further comprises an adjustable foot apparatus to level the budding foliage cultivation table, and a lateral bracing assembly to stabilize the budding foliage cultivation table during use and nonuse. The budding foliage growing surface comprise steel, square tubing having a plurality of thickness levels to increase budding foliage density during use of the budding foliage cultivation table. The roller guide assembly further comprises a cam lock, which is attached to the roller guide assembly, and comprises a steel rotary dial mechanism to facilitate moving and stabilizing the budding foliage cultivation table during use and nonuse of the budding foliage cultivation table. The strut assembly of the base assembly comprises a plurality of adjustable strut rods, to facilitate maintaining the base assembly in a vertical, stationary position during both use and nonuse of the inventive budding foliage cultivation table according to the present invention.

### DRAWINGS

FIG. 1 illustrates a schematic diagram of a front view of the overall inventive budding foliage cultivation table, comprising the inventive cam lock, locking hole, bumper, roller guide assembly, and trellis mount according to the present invention.

FIG. 2 illustrates a side view of the inventive budding foliage cultivation table, comprising the inventive carriage assembly, corresponding trailer assembly, and trellis mount according to the present invention.

FIG. 3 illustrates a front view of the inventive roller guide assembly, which comprises a component of the inventive budding foliage cultivation table base according to the present invention.

FIG. 4 illustrates a top view of the inventive roller guide assembly, which comprises a component of the inventive budding foliage cultivation table base according to the present invention.

FIG. 5 illustrates both a top view and a side view of the inventive lateral bracing assembly comprising a component of the inventive budding foliage cultivation table base according to the present invention.

FIG. 6A illustrates a side view of the inventive budding foliage cultivation table, comprising the inventive carriage assembly, corresponding trailer assembly comprising a plurality of trailer units, trellis mount and trellis net according to the present invention.

FIG. 6B illustrates a front view of the inventive budding foliage cultivation table, comprising the inventive carriage assembly, corresponding trailer assembly, strut assembly, trellis mount and trellis net according to the present invention.

FIG. 7 illustrates a top view of the carriage assembly connector, which links together the inventive carriage assembly, and plurality of trailer units according to the present invention.

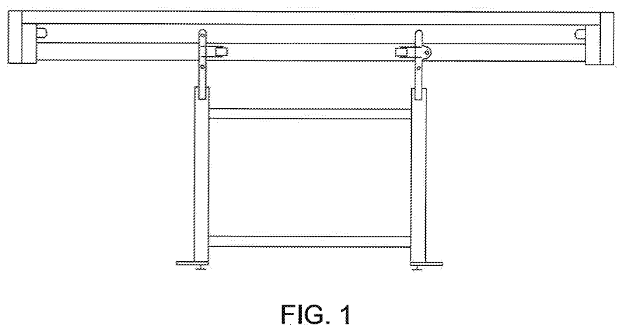

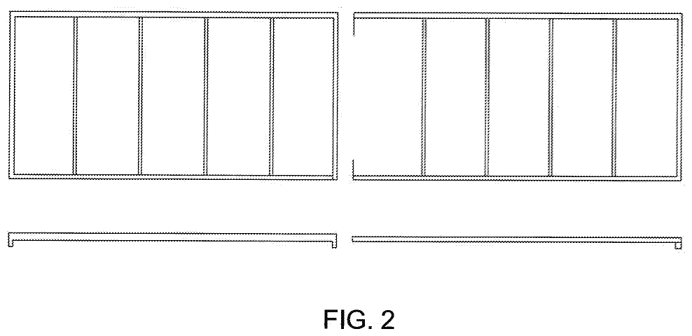

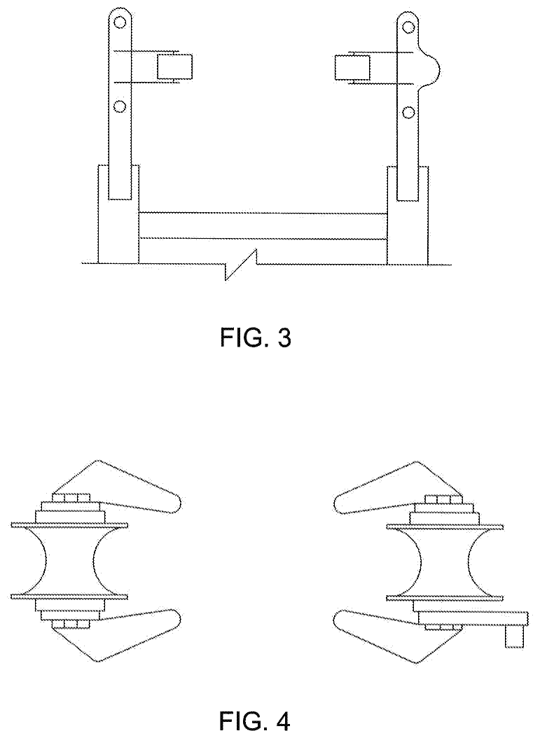

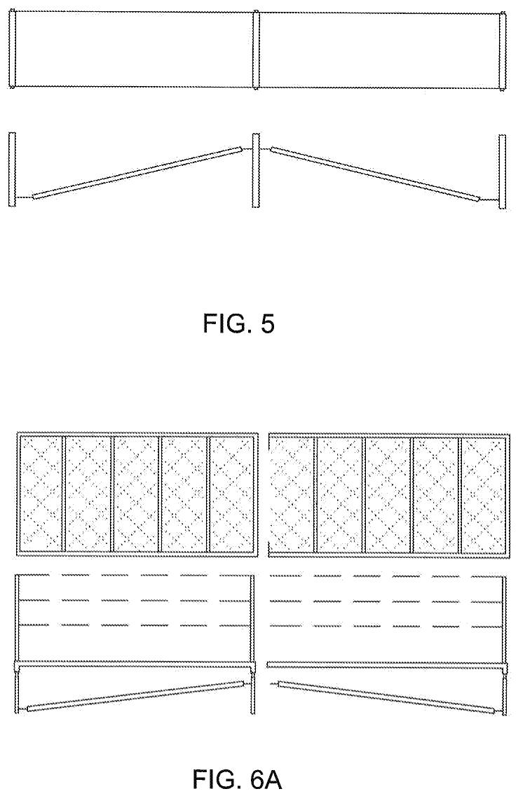

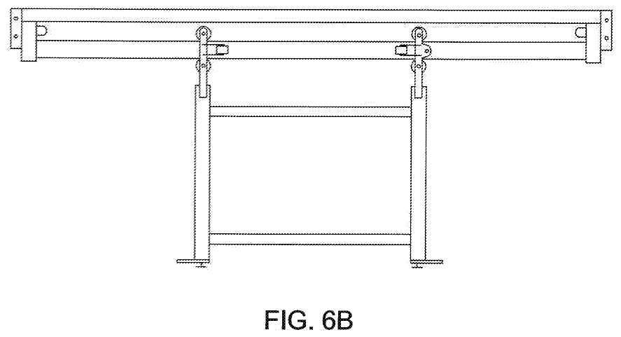

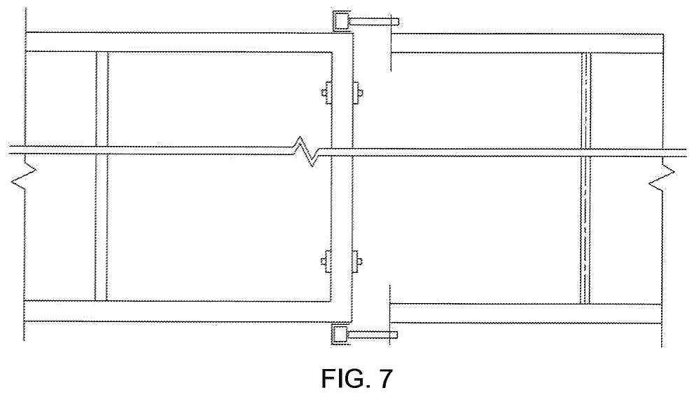

### DETAILED DESCRIPTION

The present invention is a budding foliage cultivation table, comprising a cultivation table surface, cultivation table base, strut assembly, carriage assembly, trailer assembly, roller guide assembly, lateral bracing assembly, cam lock, locking hole, bumper unit, trellis mount and trellis net assembly.

According to the present invention, the inventive budding foliage cultivation table surface comprises mild steel square tubing with varying levels of thickness. The inventive budding foliage cultivation table surface is fully welded and comprises powder coating for superior corrosion protection.

Further, according to the present invention, the inventive budding foliage cultivation table base comprises a plurality of anchor plates to secure the inventive budding foliage cultivation table base to a floor surface. The inventive budding foliage cultivation table base further comprises an adjustable foot for leveling the inventive budding foliage cultivation table, a lateral bracing assembly to stabilize the inventive budding foliage cultivation table base, and an inventive roller guide assembly as more fully explained below.

Further, according to the present invention, the inventive roller guide assembly comprises a plurality of vertical aluminum rollers. The lower rollers allow a surface for the inventive budding foliage cultivation table to travel on, while the upper rollers are constructed to prevent the inventive budding foliage cultivation table from flipping over and off of the inventive budding foliage cultivation table base. The lateral rollers keep the inventive budding foliage cultivation table from binding, to ensure smooth transition during forward and backward movement of the inventive budding foliage cultivation table during use.

Further, according to the present invention, the inventive cam lock, which is attached to the inventive roller guide assembly, comprises a steel rotary dial mechanism, which when turned left or right will retract, allowing the inventive budding foliage cultivation table to transition to a desired position and lock the inventive budding foliage cultivation table in a preferred location.

Further, according to the present invention, the inventive strut assembly comprises a plurality of adjustable strut rods, which are constructed to maintain the inventive budding foliage cultivation table base in a vertical, secured position.

Further, according to the present invention, the inventive carriage assembly comprises a cultivation table growing surface, which further comprises square tubing mild steel that is fully welded with grounded corners creating a smooth surface. The carriage assembly further comprises a round guide tube, which is positioned between the lower base rollers and the upper base rollers. The growing surface is positioned atop the lower base rollers and beneath the upper base rollers of the inventive roller guide assembly. The inventive carriage assembly further comprises a plurality of locking holes, which lock the growing surface in a desired position.

Further, according to the present invention, the inventive trailer assembly comprises a plurality of trailer units. A first trailer unit is attached to the inventive carriage assembly according to the present invention. An additional trailer unit may be attached to the first trailer unit. Additional trailer units may be linked together, as needed, by a plurality or grade 8 bolts, which are positioned at adjoining points of contact on the inventive carriage assembly according to the present invention.

Further, according to the present invention, the bumper unit comprises a segment of steel bolted to the inventive carriage assembly and inventive trailer assembly in order to prevent metal-to-metal contact of the inventive carriage assembly.

Further, according to the present invention, the inventive trellis mount is welded to both the inventive carriage assembly and inventive trailer assembly. and comprises a single unit welded to the inventive carriage assembly and inventive trailer assembly according to the present invention.

Further, according to the present invention, the inventive trellis net assembly comprises an extended rod, which has a plurality of connection points, which connect the multi-layer inventive trellis net assembly to the inventive carriage assembly and inventive trailer assembly according to the present invention.

In a preferred embodiment of the present invention, multiple inventive budding foliage cultivation table units are positioned laterally side by side in a warehouse or other spacious workplace environment. A conventional tray insert is placed atop each inventive budding foliage cultivation table surface to maximize the density of plants being grown using the inventive budding foliage cultivation table according the present invention. The inventive roller guide assembly facilitates sliding each inventive budding foliage cultivation table laterally away from, or toward, another laterally positioned inventive budding foliage cultivation table unit, such that a 36-inch ADA complaint isle space may be created between each of the laterally disposed inventive budding foliage cultivation table units, allowing workers and others to access the entire length, and full perimeter, of each inventive budding foliage cultivation table during use according to the present invention. The inventive budding foliage cultivation table is constructed to move laterally 36 inches in order to create ADA complaint isle spaces during use according to the present invention.

While the present disclosure has been disclosed with references to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. A budding foliage cultivation table comprising:
A. A carriage assembly, comprising a budding foliage growing surface;
B. A taller assembly, comprising a plurality of trailer units attached to said budding foliage growing surface;
C. A roller guide assembly, comprising a plurality of aluminum rollers, to facilitate lateral movement of said budding foliage growing surface and said budding foliate cultivation table; and
D. A base assembly, comprising a strut assembly, and plurality of anchor plates, to support and stabilize said budding foliage cultivation table in a desired location.

2. The budding foliage cultivation table of claim 1, wherein said budding foliage growing surface comprises a fully welded structure having a powder coating to facilitate corrosion protection.

3. The budding foliage cultivation table of claim 1, wherein said carriage assembly further comprises a plurality of locking holes, which lock said budding foliage growing surface into a desired, stationary position.

4. The budding foliage cultivation table of claim 1, wherein a first trailer unit is attached to said carriage assembly, to facilitate increasing budding foliage density during use of said budding foliage cultivation table.

5. The budding foliage cultivation table of claim 4, wherein a plurality of additional trailer units are sequentially attached to said first trailer unit to increase budding foliage density during use of said budding foliage cultivation table.

6. The budding foliage cultivation table of claim 1, wherein a bumper unit comprising a segment of steel is bolted to said carriage assembly and to said trailer assembly, to inhibit metal-to-metal contact during use and nonuse of said budding foliage cultivation table.

7. The budding foliage cultivation table of claim 1, wherein a trellis net assembly comprising a trellis mount is welded to said carriage assembly and to said trailer assembly, to increase budding foliage density during use of said budding foliage cultivation table.

8. The budding foliage cultivation table of claim 7, wherein said trellis net assembly further comprises an extended rod, having a plurality of connection points, to facilitate connecting said trellis net assembly to said carriage assembly and to said trailer assembly, to increase budding foliage density during use of said budding foliage cultivation table.

9. The budding foliage cultivation table of claim 1, wherein a plurality of tray inserts are positioned atop said budding foliage growing surface of said carriage assembly, to increase budding foliage density during use of said budding foliage cultivation table.

10. The budding foliage cultivation table of claim 1, wherein said roller guide assembly comprises: a plurality of lower aluminum rollers, which facilitate providing a surface upon which said budding foliage cultivation table can move laterally; a plurality of upper aluminum rollers, which prevent said budding foliage cultivation table from disengaging with said base assembly; and a plurality of lateral aluminum rollers, which prevent said budding foliage cultivation table from binding, to facilitate smooth transition during movement of said budding foliage cultivation table.

11. The budding foliage cultivation table of claim 1, wherein said roller guide assembly facilitates moving laterally said budding foliage cultivation table during use, to achieve at least a 36-Inch isle space during use of said budding foliage cultivation table.

12. The budding foliage cultivation table of claim 1, wherein said base assembly further comprises an adjustable foot apparatus to level said budding foliage cultivation table, and a lateral bracing assembly to stabilize said budding foliage cultivation table during use and nonuse.

13. The budding foliage cultivation table of claim 1, wherein said budding foliage growing surface comprise steel, square tubing having a plurality of thickness levels to increase budding foliage density during use of said budding foliage cultivation table.

14. The budding foliage cultivation table of claim 1, wherein said roller guide assembly further comprises a cam lock, which is attached to said roller guide assembly, and comprises a steel rotary dial mechanism to facilitate moving and stabilizing said budding foliage cultivation table during use and nonuse of said budding foliage cultivation table.

15. The budding foliage cultivation table of claim 1, wherein said strut assembly of said base assembly comprises a plurality of adjustable strut rods, to facilitate maintaining said base assembly in a vertical, stationary position.
